(19) United States
(12) Patent Application Publication
(10) Pub. No.: US 2024/0144532 A1
(43) Pub. Date: May 2, 2024

(54) CALIBRATION METHOD FOR CAMERA, and CAMERA CALIBRATION SYSTEM

(71) Applicant: SEIKO EPSON CORPORATION, Tokyo (JP)

(72) Inventor: Nobuhiro KARITO, KISO-MACHI (JP)

(21) Appl. No.: 18/385,914

(22) Filed: Nov. 1, 2023

(30) Foreign Application Priority Data
Nov. 2, 2022 (JP) 2022-176543

(51) Int. Cl. G06T 7/80; G06T 7/246; G06V 20/60

(52) U.S. Cl. CPC G06T 7/80; G06T 7/248; G06V 20/60; G06T 2207/30164; G06T 2207/30244

(57) ABSTRACT

A calibration method of the present disclosure includes a calibration step of executing a calibration process for obtaining an external parameter of a camera with respect to a robot using a first image that was taken by the camera and that includes at least a part of a robot and a judgment step of judging validity of the external parameter after execution of a calibration process. The judgment step includes (a) a step of taking a second image including at least a part of the robot by the camera after execution of the calibration process and (b) a step of judging whether or not a positional relationship between the camera and the robot has changed using the first image and the second image, and judging whether the external parameter is valid or invalid in accordance with presence or absence of change in the positional relationship.

The present application is based on, and claims priority from JP Application Serial Number 2022-176543, filed Nov. 2, 2022, the disclosure of which is hereby incorporated by reference herein in its entirety.

### BACKGROUND

### 1. Technical Field

The present disclosure relates to a calibration method for a camera and a camera calibration system.

### 2. Related Art

When a camera is used in robot work, a calibration parameter of the camera is set by performing calibration in advance. The calibration parameters include internal parameters representing the capability of a lens or the relationship between a lens and pixels, and external parameters representing the relative position between the camera and the robot.

WO 2018/168255 discloses a method for obtaining a camera calibration parameter. In this related art, first, an error function representing a transformation between six or more sets of three dimensional points relating to an object and two dimensional points on an image corresponding to each of the three dimensional points is divided into a plurality of partial problems, and an optimal solution candidate is calculated for each of the partial problems. Then, an optimal solution that minimizes an error obtained by the error function is obtained using the optimal solution candidate as an initial value, and the optimal solution is obtained as an optimal camera calibration parameter.

However, in the above-described related art, when an object having six or more sets of three dimensional points is photographed, it is necessary to accurately arrange a calibration jig at a predetermined position in a field of view of the camera. This arrangement condition may be difficult when the object is a robot. For example, in a case after the robot starts work, it may be difficult to secure a space for arranging the calibration jig around the robot, and a user may be forced to change work environment. In an environment in which the operation range of a robot dynamically changes, such as in the case of a robot that is not surrounded by a fence and that performs work next to a human, it is necessary to change installation position of the camera every time work content is switched. Therefore, every time the work content changes, a user is forced to perform work to obtain the calibration parameter. Therefore, a technique is desired that can easily perform a calibration process for a camera without using a special calibration jig.

When a relative position of the camera and the robot changes after the calibration process for the camera has been performed once, the calibration parameter becomes invalid. Therefore, a technique is desired for after the calibration process that enables easily judging whether the calibration parameter is valid or not.

The present disclosure has been made to solve at least a part of the above-described problems.

### SUMMARY

According to a first aspect of the present disclosure, a calibration method for a camera is provided.

This calibration method includes a calibration step of executing a calibration process for obtaining an external parameter of the camera with respect to a robot using a first image that was taken by the camera and that includes at least a part of the robot and a judgment step of judging validity of the external parameter after execution of the calibration process. The judgment step includes (a) a step of, after execution of the calibration process, using the camera to take a second image including at least a part of the robot and (b) a step of judging whether or not a positional relationship between the camera and the robot has changed using the first image and the second image, and judging whether the external parameter is valid or invalid in accordance with presence or absence of change in the positional relationship.

According to a second aspect of the present disclosure, a camera calibration system is provided.

This camera calibration system includes a robot; a camera installed configured to photograph the robot; a calibration execution section configured to execute a calibration process of obtaining an external parameter of the camera with respect to the robot using a first image that was taken by the camera and that includes at least a part of the robot; and a judgment section configured to judge validity of the external parameter after execution of the calibration process. The judgment section judges whether or not a positional relationship between the camera and the robot has changed using the first image and a second image that was taken by the camera after execution of the calibration process and that includes at least part of the robot, and executes a judgment process of judging whether the external parameter is valid or invalid in accordance with presence or absence of change in the positional relationship.

According to a third aspect of the present disclosure, a calibration method for a camera is provided.

This calibration method includes a calibration step of executing a calibration process for obtaining an external parameter of the camera with respect to a robot using a first image that was taken by the camera and that includes at least a part of the robot, wherein the calibration step is a step of recognizing a specific portion that enables determining a pose of the robot from the first image and estimating the external parameter from a recognition result of the specific portion.

### BRIEF DESCRIPTION OF THE DRAWINGS

FIG. 1 is an explanatory diagram showing configuration of a camera calibration system.

FIG. 2 is a conceptual diagram showing a relationship among various coordinate systems.

FIG. 3 is a functional block diagram of an information process device.

FIG. 4 is a flowchart showing a work procedure of a robot that accompanies a calibration process for a camera.

FIG. 5 is an explanatory diagram showing contents of the calibration process according to a first embodiment.

FIG. 6 is a flowchart showing a procedure of a movement judgment process of a camera according to the first embodiment.

FIG. 7 is an explanatory diagram showing contents of the movement judgment process of the camera according to the first embodiment.

FIG. 8 is a flowchart showing a procedure of a movement judgment process of a camera according to a second embodiment.

FIG. 9 is an explanatory diagram showing contents of the movement judgment process of the camera according to the second embodiment.

FIG. 10 is an explanatory diagram showing contents of a calibration process according to a third embodiment.

### DESCRIPTION OF EMBODIMENTS

### A. First Embodiment

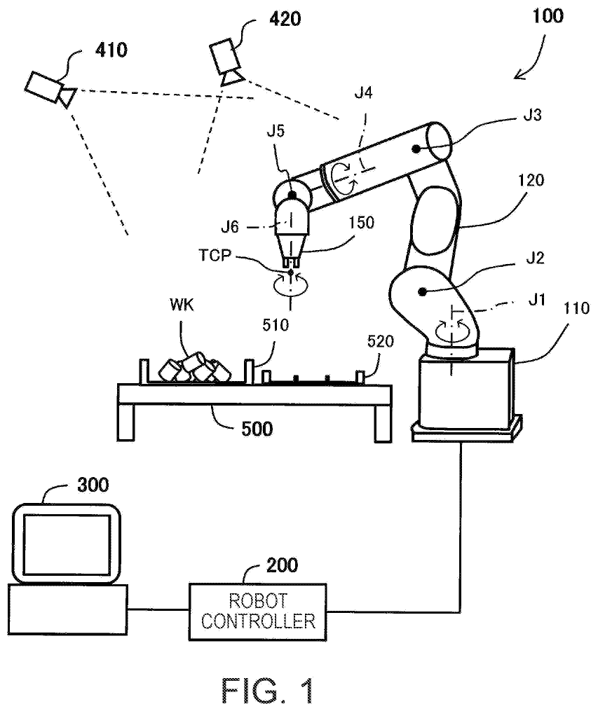

FIG. 1 is an explanatory diagram showing an example of a camera calibration system according to an embodiment. This system is a robot system including a robot 100, a robot controller 200 that controls the robot 100, an information process device 300, cameras 410 and 420, and a workbench 500. The information processing device 300 has a function as a calibration process device that determines calibration parameters of the cameras 410 and 420, and is realized by a personal computer, for example.

The robot 100 includes a base 110, which is a non-movable section, and a robot arm 120, which is a movable section. A robot hand 150 as an end effector is attached to a tip end section of the robot arm 120. The robot hand 150 can be realized as a gripper or a suction pad capable of gripping a workpiece WK. A tool center point (TCP) as a control point of the robot 100 is set at a tip end section of the robot hand 150. The control point TCP can be set at an arbitrary position.

The robot arm 120 is sequentially connected at six joints J1 to J6. Of these joints J1 to J6, three joints J2, J3, and J5 are bending joints, and the other three joints J1, J4, and J6 are torsional joints. Although a six axes robot is exemplified in the present embodiment, a robot including an arbitrary robot arm mechanism including a plurality of joints can be used. Although the robot 100 of the present embodiment is a vertical articulated robot, a horizontal vertical articulated robot may be used.

The workbench 500 is provided with a first container 510 and a second container 520. A plurality of workpieces WK are contained in the first container 510. The second container 520 is used as a place where the workpieces WK taken out from the first container 510 are placed. The robot 100 performs the work of taking out a workpiece WK from the first container 510 and placing the workpiece WK on the second container 520. At this time, the workpiece WK is placed at a predetermined position in the second container 520 in a predetermined orientation. In order to accurately perform this work, a pose of the workpiece WK is recognized using the cameras 410 and 420. The second container 520 may be transported by a transport belt. Alternatively, the first container 510 may be omitted, and the workpiece WK may be transported by a transport belt.

Cameras 410 and 420 for taking the workpieces WK and the robot 100 are installed above the workbench 500. Images taken by the cameras 410 and 420 are used to obtain three dimensional positions and orientations of each of the workpieces WK and the robot 100. In the present disclosure, three dimensional position and orientation of an object are referred to as “pose”. Recognition of a pose of an object is simply referred to as “object recognition”.

In the present embodiment, a plurality of cameras 410 and 420 are used to avoid obstacles while operating the robot arm 120 during work. Work may be performed using only one camera 410. When work is performed using a plurality of cameras, a calibration process to be described later is executed for each camera. A case where a calibration process is mainly performed for the first camera 410 will be described below.

In the calibration process for the camera 410, a calibration parameter is determined using an image that was taken by the camera 410 and that includes at least a part of the robot 100. In this case, an image portion of the non-movable section included in the image is used. As the non-movable section, for example, the following can be used.
(a) the base 110 of the robot 100
(b) a workbench or a platform on which the base 110 of the robot 100 is installed These non-movable sections are fixed portions that do not move or change during work of the robot 100 and are present at fixed positions.

In the present embodiment, the base 110 of the robot 100 is used as the non-movable section. Therefore, it is desirable that the camera 410 is installed in a state where both of the workpieces WK and the base 110 can be photographed. A calibration process for the camera 410 will be described later in detail.

As the camera 410, for example, an RGBD camera or a stereo camera is preferably used, but a monocular camera may also be used. The RGBD camera is a camera including an RGB camera that takes an RGB image and a D camera that takes a depth image. The same applies to the camera 420.

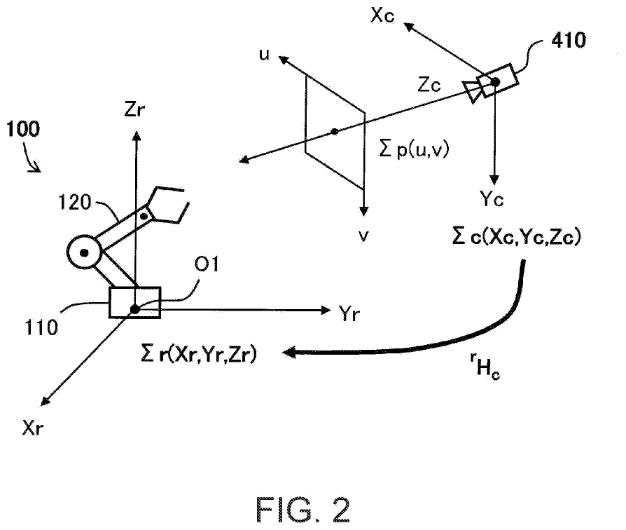

FIG. 2 is a conceptual diagram showing a relationship of coordinate systems described below. In FIG. 2, the robot 100 is simplified.

### (1) Robot Coordinate System Σr

The robot coordinate system Σr is an orthogonal three dimensional coordinate system having a predetermined position of the robot 100 as the coordinate origin. In the present embodiment, it is assumed that the origin O1 of the robot coordinate system Σr coincides with a specific position or a reference position of the base 110 which is a non-movable section. However, it is not necessary for the two to match, and when the relative positional relationship between the two is known, it is possible to determine an external parameter of the camera 410 by a calibration process (to be described later).

### (2) Camera Coordinate System Σc

The camera coordinate system Σc is an orthogonal three dimensional coordinate system having a predetermined position of the camera 410 as a coordinate origin.

### (3) Pixel Coordinate System Σp

The pixel coordinate system Σp is an orthogonal two dimensional coordinate system of images taken by the camera 410.

The pixel coordinate values (u, v) of the pixel coordinate system Σp and the three dimensional coordinate values (Xc, Yc, Zc) of the camera coordinate system Σc can be transformed using an internal parameter of the camera 410 as shown in the following equation.

$$\begin{matrix}Equation 1 & \\ [ \begin{matrix}u \\ v \\ 1\end{matrix} ] = [ \begin{matrix}{k}_{x} & 0 & {O}_{x} \\ 0 & {k}_{y} & {O}_{y} \\ 0 & 0 & 1\end{matrix} ] [ \begin{matrix}f & 0 & 0 & 0 \\ 0 & f & 0 & 0 \\ 0 & 0 & 1 & 0\end{matrix} ] [ \begin{matrix}Xc \\ Yc \\ Zc \\ 1\end{matrix} ] & ( 1 )\end{matrix}$$

Here, Kx and Ky are distortion coefficients, Ox and Oy are optical centers, and f is focal length.

The three dimensional coordinate values (Xc, Yc, Zc) of the camera coordinate system Σc and the three dimensional coordinate values (Xr, Yr, Zr) of the robot coordinate system Σr can be transformed using a homogeneous transformation matrix ^{r}H_{c} represented by an external parameter of the camera 410 as shown in the following equation.

$$\begin{matrix}Equation 2 & \\ [ \begin{matrix}Xr \\ Yr \\ Zr \\ 1\end{matrix} ] = {}^{r} {H}_{c} [ \begin{matrix}Xc \\ Yc \\ Zc \\ 1\end{matrix} ] = [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ] [ \begin{matrix}Xc \\ Yc \\ Zc \\ 1\end{matrix} ] & ( 2 )\end{matrix}$$

Here, r₁₁ to r₃₃ are elements of the rotation matrix and tₓ, t_{y}, and t_{z} are elements of the translation vector.

In the present embodiment, it is assumed that internal parameters among calibration parameters of the camera 410 are set in advance. A calibration process is performed to determine an external parameter.

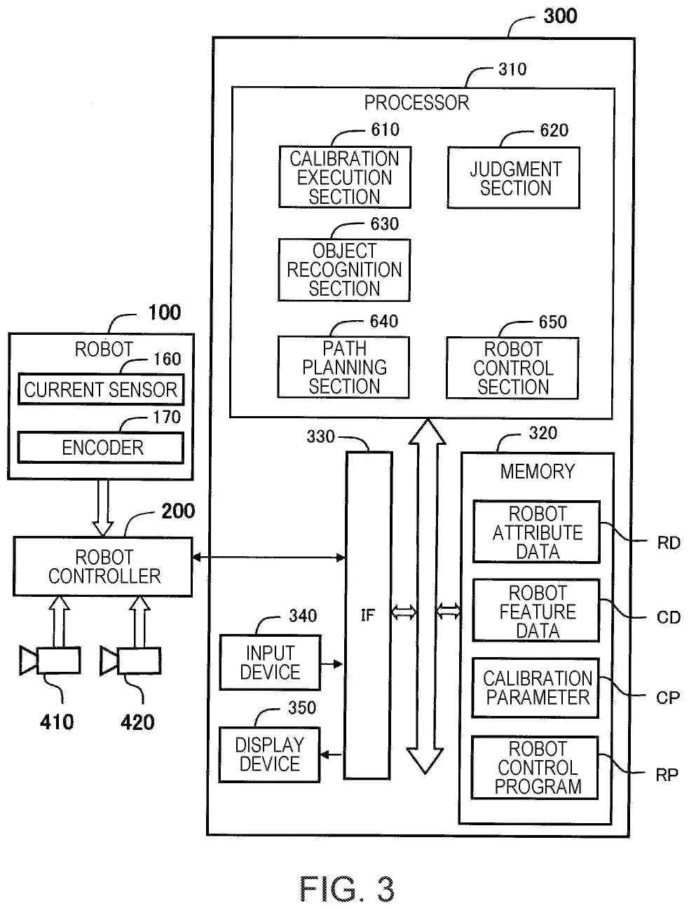

FIG. 3 is a block diagram showing functions of the information process device 300. The information process device 300 includes a processor 310, a memory 320, and an interface circuit 330. An input device 340 and a display device 350 are connected to the interface circuit 330, and a robot controller 200 is also connected to the interface circuit 330. The robot controller 200 is connected to the cameras 410 and 420, and is also connected to a current sensor 160 that measures a motor current of each joint of the robot 100 and an encoder 170 that measures displacement of each joint.

The processor 310 has functions of a calibration execution section 610, a judgment section 620, an object recognition section 630, a path planning section 640, and a robot control section 650. The calibration execution section 610 determines external parameters of the cameras 410 and 420 by executing a calibration process for the cameras 410 and 420 with respect to the robot 100. The judgment section 620 executes a judgment process for judging validity of an external parameter after execution of the calibration process. The object recognition section 630 executes a process of recognizing the workpieces WK and obstacles using images taken by the cameras 410 and 420 during work of the robot 100. The path planning section 640 calculates a movement path so that the robot arm 120 does not collide with obstacles or the robot 100 itself, and notifies the robot control section 650 of the movement path. The movement path is a group of discrete orientations of the robot arm 120. The robot control section 650 moves the robot arm 120 along the movement path, and executes a process of causing the robot 100 to perform work related to the workpieces WK. The functions of these sections are realized by the processor 310 executing a computer program stored in the memory 320. Some or all of the functions of the sections may be realized by a hardware circuit.

The memory 320 stores robot attribute data RD, robot feature data CD, calibration parameters CP, and a robot control program RP. The robot attribute data RD is data indicating attributes such as a mechanical structure and a movable range of the robot 100, and includes CAD data representing an outer shape of the robot 100. The robot feature data CD includes data representing features of the base 110, which is a non-movable section. The calibration parameters CP includes internal parameters and external parameters for each of the cameras 410 and 420. The robot control program RP is composed of a plurality of commands for operating the robot 100.

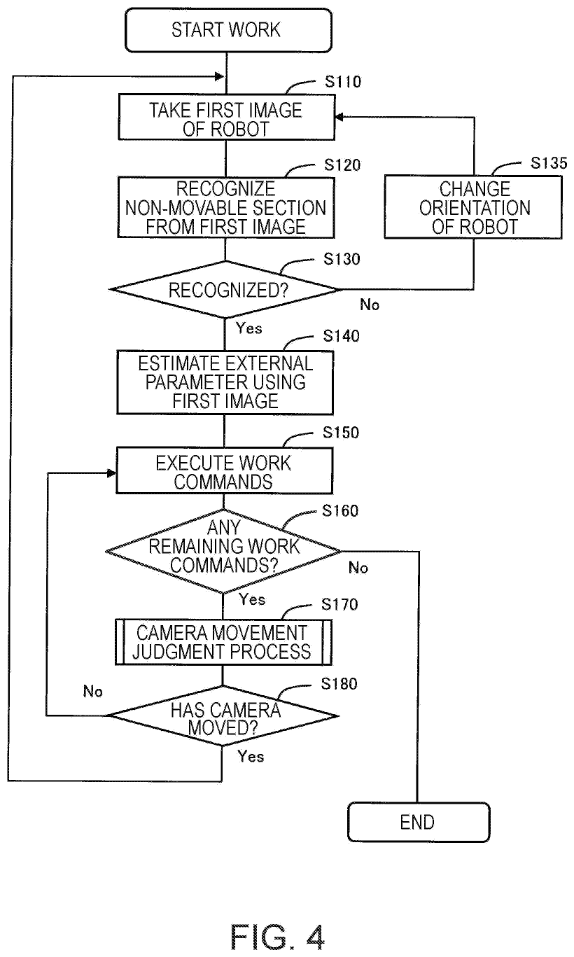

FIG. 4 is a flowchart showing a work procedure of the robot that accompanies the calibration process for the camera. A case where the calibration process is performed mainly for the first camera 410 will be described below, but the calibration process is also performed for the second camera 420 in the same manner.

In step S110, the calibration execution section 610 uses the camera 410 to take a first image that includes at least a part of the robot 100. The first image is an image including at least the base 110, which is a non-movable section.

In step S120, the calibration execution section 610 recognizes the base 110, which is a non-movable section, from the first image using the CAD data of the robot 100. In step S130, it is judged whether or not the base 110 has been recognized. This judgment can be performed, for example, in accordance with a degree of reliability of a recognition result of the base 110 by the calibration execution section 610. A recognition process of an object by the calibration execution section 610 and the object recognition section 630 is desirably configured to also output a degree of reliability (confidence value) of the recognition result. When the degree of reliability of the recognition result is lower than a threshold, it is judged that the object is not recognized. In a case where the base 110 is hidden by the robot arm 120 and a part of the base 110 is not seen, the base 110 will not be recognized, whereupon the process proceeds to step S135, an orientation of the robot 100 is changed, the process returns to step S110, and the first image is photographed again. In step S135, it is desirable that the robot arm 120 takes a preset calibration orientation. The calibration orientation is an orientation in which the base 110, which is a non-movable section, is not hidden by the robot arm 120 in the field of view of the camera 410. The calibration orientation may be different for each of the cameras 410 and 420, or may be a common orientation for the cameras 410 and 420.

In step S140, the calibration execution section 610 estimates an external parameter of the camera 410 using the first image. As an external parameter estimation method, for example, the following method can be considered.

External Parameter Estimation Method M1
(1a) A plurality of reference features of the base 110 are extracted and stored in advance from the CAD data of the base 110, which is a non-movable section. As “features”, a specific line segment such as an edge, a specific point, or the like can be used.
(1b) A plurality of image features of the base 110 are extracted from the first image.
(1c) Six degree-of-freedom information indicating a pose of the base 110 in the camera coordinate system Σc is determined from a relationship between a plurality of reference features and a plurality of image features.
(1d) An external parameter is determined from a pose of the base 110 in the camera coordinate system Σc.

As a specific method of the above-described processes (1a) to (1c), for example, methods disclosed in JP-A-2013-50947 and JP-A-9-167234 may be used. In a method disclosed in JP-A-2013-50947, a binary mask of an image including an object is first created, and a set of singlets is extracted from the binary mask. Each singlet represents a point within inner and outer contours of an object in an image. A set of singlets is then concatenated into a mesh represented as a duplex matrix, two duplex matrices are compared to create a set of candidate orientations, and an orientation of an object is estimated by an object orientation estimate. According to the method disclosed in JP-A-9-167234, a CAD graphic feature amount derived by projecting an object onto an orthogonal plane of a predetermined direction is calculated, a camera graphic feature amount in a two dimensional image obtained from the object taken by a camera from a predetermined direction is calculated, and the CAD graphic feature amount and the camera graphic feature amount are compared to estimate a pose of an object taken by the camera.

External Parameter Estimation Method M2
(2a) A machine learning model configured to receive the first image as an input and output a pose of the base 110, which is a non-movable section, is created, and a machine learning model that was subjected to learning is stored.
(2b) A first image including the base 110 is input to a machine learning model to obtain six degree-of-freedom information indicating a pose of the base 110 in the camera coordinate system Σc.
(2d) An external parameter is determined from a pose of the base 110 in the camera coordinate system Σc.

As a machine learning model, for example, a convolutional neural network can be used. A machine learning model may be configured to receive the first image as input and to output an external parameter.

The processes (1a) to (1c) and the processes (2a) to (2b) described above can also be used for object recognition by the object recognition section 630.

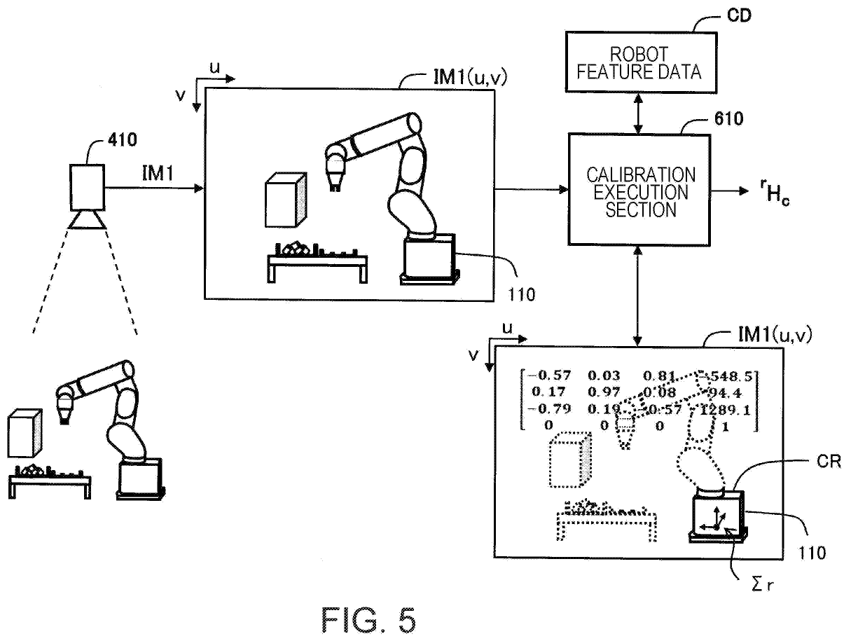

FIG. 5 is an explanatory diagram showing contents of the calibration process according to the first embodiment. Here, the first estimation method M1 described above is used. First, the calibration execution section 610 extracts an image feature CR related to the base 110 using a first image IM1 taken by the camera 410. In the lower right of FIG. 5, an image feature CR extracted from a first image IM1 is drawn by solid lines, and the other outer shapes are drawn by dotted lines. An image feature CR related to the base 110 can be obtained, for example, by extracting edges or the like of a first image IM1 to create a large number of image features, and selecting an image feature that matches an outer shape of the base 110 represented by CAD data of the robot 100 from the image features. The calibration execution section 610 estimates six degree-of-freedom information of a pose of the base 110 from the relationship between an image feature CR related to the base 110 and a reference feature set in advance, and determines an external parameter of the camera 410 from the pose of the base 110. A reference feature is prepared in advance as the robot feature data CD shown in FIG. 3.

A pose of the base 110 can be expressed as a homogeneous transformation matrix ^{c}Hᵣ for transforming coordinates of the robot coordinate system Σr into coordinates of the camera coordinate system Σc. In a first image IM1 shown in a lower part of FIG. 5, an example of a homogeneous transformation matrix ^{c}Hᵣ shown in the following equation is displayed.

$$\begin{matrix}Equation 3 & \\ {}^{c} {H}_{r} = [ \begin{matrix}R & t \\ 0 & 1\end{matrix} ] = [ \begin{matrix}- 0.57 & 0.03 & 0.81 & - 548.5 \\ 0.17 & 0.97 & 0.08 & 94.4 \\ - 0.79 & 0.19 & - 0.57 & 1289.1 \\ 0 & 0 & 0 & 1\end{matrix} ] & ( 3 )\end{matrix}$$

Here, R is a rotation matrix and t is a translation vector.

Translation vector t=[−548.5, 94.4, 1289.1]^{T} represents a specific position of the base 110 as viewed in the camera coordinate system Σc, that is, a coordinate of the origin position O1 of the robot coordinate system Σr. The three column components of the rotation matrix R are equal to components of the three basis vectors of the robot coordinate system Σr viewed in the camera coordinate system Σc.

This homogeneous transformation matrix ^{c}Hᵣ is an inverse matrix of a homogeneous transformation matrix ^{r}H_{c} as an external parameter, and both can be easily transformed as shown in the following equation.

$$\begin{matrix}Equation 4 & \\ {}^{r} {H}_{c} = {}^{c} {H}_{r}^{- 1} = {[ \begin{matrix}R & t \\ 0 & 1\end{matrix} ]}^{- 1} = [ \begin{matrix}{R}^{T} & - {R}^{T} \cdot t \\ 0 & 1\end{matrix} ] & ( 4 )\end{matrix}$$

Here, R^{T} is a transposed matrix of the rotation matrix R. In general, an inverse matrix R⁻¹ of a rotation matrix R is equal to a transposed matrix R^{T}.

In this manner, the calibration execution section 610 can obtain an installation position and an installation direction of the robot 100 in the camera coordinate system Σc by using the camera 410 to photograph the base 110, which is a non-movable section near a basal section of the robot 100, and recognizing a pose of the base 110. It is also possible to estimate an external parameter of the camera 410 using this recognition result.

When a calibration process is performed for cameras 410 and 420, steps S110 to S140 are executed for each camera. Processes of steps S110, S120, S130, and S135 may be repeatedly executed for all of a plurality of cameras until the base 110, which is a non-movable section, can be correctly recognized.

The calibration execution section 610 may acquire a plurality of first images IM1 by taking the non-movable section with the same camera at a plurality of timings, and determine an external parameter of the camera by using an average of a plurality of external parameters estimated from the plurality of first images IM1. This allows an external parameter to be determined more accurately.

When a calibration process of the camera 410 is completed, the process proceeds to step S150 in FIG. 4, and the robot control section 650 starts work using the robot 100. In step S150, the robot control section 650 selects one work command and executes it. At this time, the object recognition section 630 recognizes workpieces WK and obstacles. The path planning section 640 creates a path plan using a recognition result of the object recognition section 630 so as to perform movement work of workpieces WK while avoiding obstacles. In step S160, the robot control section 650 judges whether or not there are any remaining work commands. When there are remaining work commands, proceed to step S170.

In step S170, the judgment section 620 executes a movement judgment process of the camera 410. In the movement judgment process, it is judged whether or not the positional relationship between the camera 410 and the robot 100 has changed using a second image of the robot 100, which was taken by the same camera 410 after execution of the calibration process of the camera 410 and the first image IM1 described above. Then, it is judged whether the external parameter of the camera 410 is invalid or valid in accordance with presence or absence of change in the positional relationship. The movement judgment process for a camera does not need to be performed every time one work command is completed, but may be performed periodically at regular time intervals.

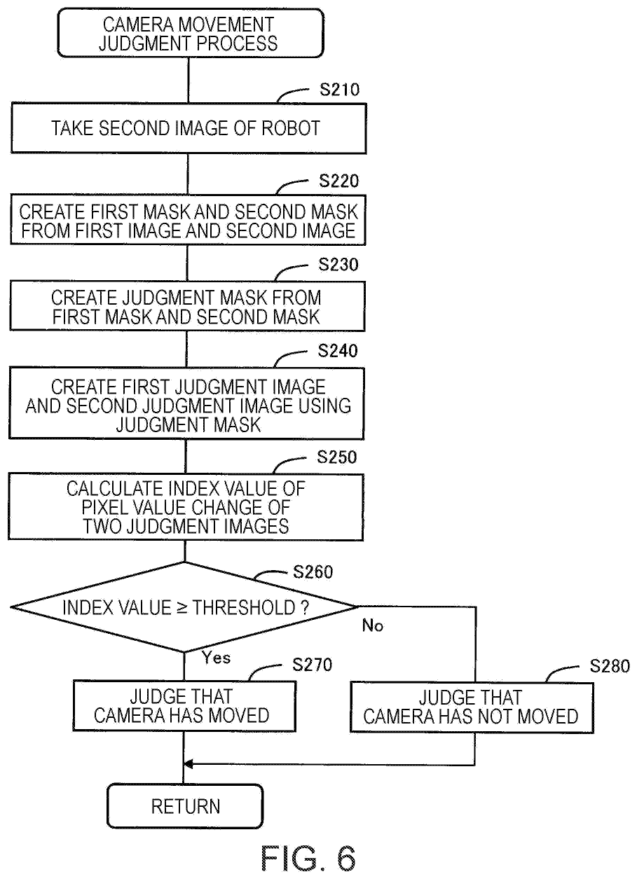

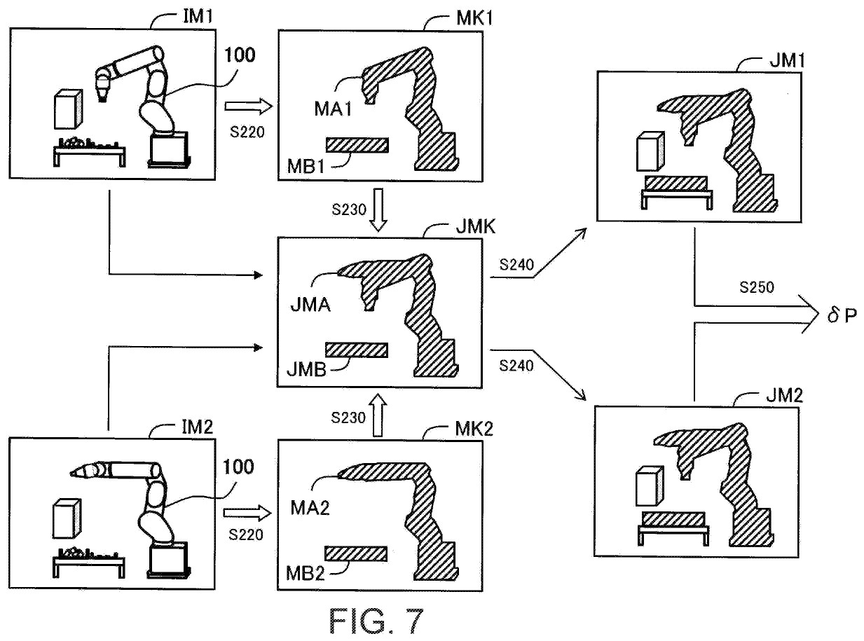

FIG. 6 is a flowchart showing the processing procedure of the movement judgment process for a camera according to the first embodiment, and FIG. 7 is an explanatory diagram showing the processing contents. In step S210, the judgment section 620 takes a second image IM2 of the robot 100 using the camera 410. When the camera 410 has not moved with respect to the robot 100, the pose of the base 110 in the second image IM2 should be the same as that in the first image IM1.

In step S220, a first mask MK1 and a second mask MK2 indicating the region of the robot 100 are created using the first image IM1 and the second image IM2, respectively. As shown in FIG. 7, the first mask MK1 includes a mask region MA1 indicating the region of the robot 100 and a mask region MB1 indicating a region of movement-allowed objects such as workpieces WK. The mask region MB1 has a rectangular shape indicating a range in which the movement-allowed objects exist. “Movement-allowed object” means an object that is allowed to move during work of the robot 100. The movement-allowed object may include at least workpiece WK. Other objects that are allowed to move during work, such as a container or a tray of the workpiece WK or a transport belt, may be used as movement-allowed objects. Similarly, the second mask MK2 includes a mask region MA2 indicating the region of the robot 100 and a mask region MB2 indicating a region of movement-allowed objects. The mask regions MB1 and MB2 indicating the regions of movement-allowed objects may be omitted. In either case, the first mask MK1 is created so as to indicate a mask region including a region of the robot 100 included in the first image IM1. Similarly, the second mask MK2 is created so as to indicate a mask region including the region of the robot 100 included in the second image IM2.

A pixel value of 1 is assigned to pixels in mask regions MA1, MA2, MB1, and MB2, and a pixel value of 0 is assigned to pixels in the other regions. Normally, since the orientation of the robot arm 120 is different between the first image IM1 and the second image IM2, the mask regions MA1 and MA2 of the robot 100 are different from each other. The mask regions MA1 and MA2 of the robot 100 in the individual images IM1 and IM2 can be calculated using CAD data representing an outer shape of the robot 100, an orientation of the robot arm 120, and an external parameter of the camera 410. The mask regions MB1 and MB2 indicating the regions of movement-allowed objects are also substantially the same. Alternatively, the image regions of the individual images IM1 and IM2 may be separated into regions of a plurality of different objects using semantic segmentation, and the mask regions MA1, MA2, MB1, and MB2 may be determined using the result. A first mask MK1 may be created prior to step S220 and after step S110 in FIG. 4.

In step S230, the judgment section 620 obtains logical sum of the first mask MK1 and the second mask MK2 to create a judgment mask JMK. In the judgment mask JMK, a mask region JMA related to the robot 100 is a sum region of the two mask regions MA1 and MA2. A mask region JMB related to movement-allowed objects is also a sum region of the two mask regions MB1 and MB2. In step S240, the judgment section 620 creates a first judgment image JM1 obtained by excluding mask regions JMA and JMB of a judgment mask JMK from a first image IM1 and a second judgment image JM2 obtained by excluding mask regions JMA and JMB of a judgment mask JMK from a second image IM2. The first judgment image JM1 is an image in which pixel values of mask regions JMA and JMB are set to zero in the first image IM1. The same applies to a second judgment image JM2.

In steps S250 and S260, the judgment section 620 judges whether or not the positional relationship between the camera 410 and the robot 100 has changed, in accordance with the change in pixel values in the first judgment image JM1 and the second judgment image JM2. Specifically, in step S250, an index value 5P is calculated for pixel value change in the first judgment image JM1 and the second judgment image JM2. As the index value 5P of the pixel value change, for example, any one of the following can be used.
(1) The average value of the absolute values |P1−P2| of the difference between a pixel value P1 of the first judgment image JM1 and a pixel value P2 of the corresponding pixel position of the second judgment image JM2. It is desirable that the average value is calculated for a region other than a mask region.
(2) The total value of the absolute values |P1−P2| described above.
(3) A value obtained by subtracting from one the cosine similarity between the first judgment image JM1 and the second judgment image JM2. It is desirable that the cosine similarity is also calculated for regions other than the mask region.

In step S260, the judgment section 620 judges whether or not an index value OP of pixel value change is equal to or greater than a predetermined threshold. When the index value OP of pixel value change is equal to or greater than the threshold, it is judged in step S270 that the camera 410 has moved. On the other hand, when the index value OP of the pixel value change is less than the threshold, it is judged in step S280 that the camera 410 has not moved.

According to the above-described movement judgment process, it is possible to judge whether or not the positional relationship between the camera 410 and the robot 100 has changed from the change in pixel values in background regions of a first image IM1 and a second image IM2. When a plurality of cameras are used, it is desirable to execute the process of FIG. 6 for each camera.

When the movement judgment process ends, it is determined in step S180 of FIG. 4 whether or not the camera has moved. When there is no movement of the camera, the calibration parameter of the camera is valid, so the process returns to step S150, and the process from step S150 described above is executed again. On the other hand, when the camera has moved, since the external parameter is invalid, the process returns to step S110, and an external parameter is newly estimated in accordance with steps S110 to S140. At this time, the robot 100 is preferably stopped until an external parameter is estimated again in accordance with steps S110 to S140.

As described above, in the first embodiment, since the calibration process for a camera is performed using a recognition result of a non-movable section included in a first image, an external parameter of the camera can be obtained from the first image without using a calibration jig. It is possible to judge whether or not the calibration parameter is valid by using the second image taken by the same camera after execution of the calibration process.

Note that the movement judgment process of the camera in step S170 may be omitted. Also in this case, the external parameter of the camera can be obtained from the first image including at least a part of the robot 100 without using a calibration jig.

### B. Second Embodiment

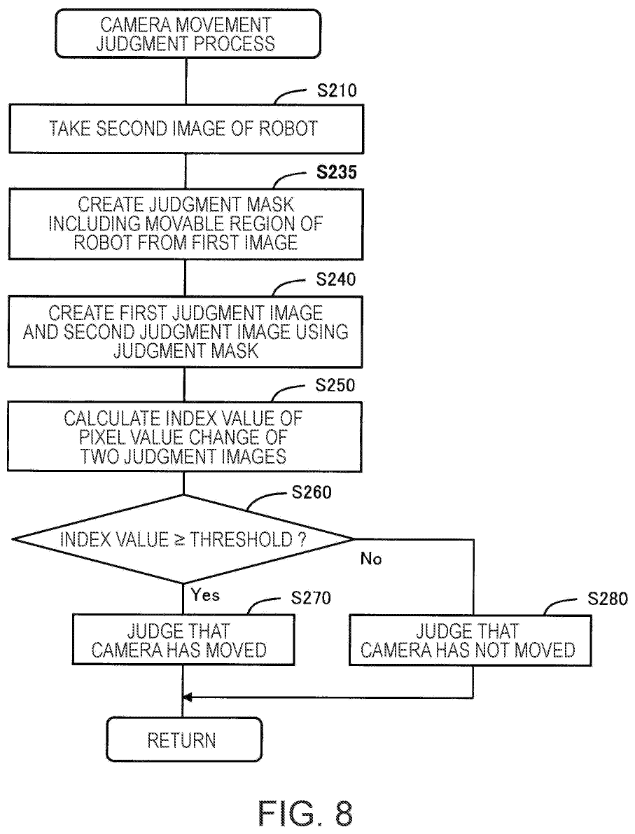

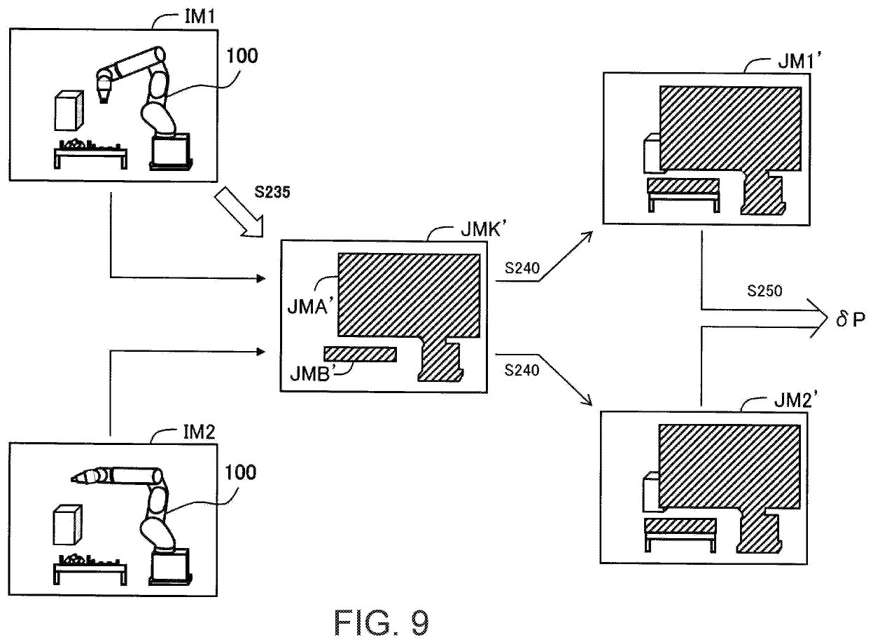

FIG. 8 is a flowchart showing a processing procedure of a movement judgment process for a camera according to a second embodiment, and FIG. 9 is an explanatory diagram showing the processing contents. The second embodiment differs from the first embodiment only in a movement judgment process of the camera, and the configuration of the system and the processing procedure of FIG. 4 are the same as those of the first embodiment. The processing procedure of FIG. 8 is obtained by replacing the two steps S220 and S230 of FIG. 6 with step S235, and the other steps are the same as those of FIG. 6.

In step 235, the judgment section 620 creates a judgment mask JMK′ including the movable region of the robot 100 by using the first image IM1. As shown in FIG. 9, the judgment mask JMK′ includes a mask region JMA′ related to the robot 100 and a mask region JMB′ related to an movement-allowed object. The mask region JMA′ related to the robot 100 is formed so as to include the movable region of the robot arm 120 in addition to the region of the robot 100 included in the first image IM1. Similarly, the mask region JMB′ related to a movement-allowed object is formed so as to include a region in which the movement-allowed object can move. However, the mask region JMB′ can be omitted. A movable region of the robot arm 120 is described in the robot attribute data RD. Since the movable region of the robot arm 120 includes a region of the robot arm 120 at an arbitrary timing, the region of the robot 100 in the second image IM2 is also included in the mask region JMA′. Therefore, the judgment mask JMK′ can be created from the first image IM1 without using the second image IM2.

The second embodiment can also exhibit substantially the same effects as the first embodiment. In the second embodiment, since the judgment mask JMK′ can be created from the first image IM1 without using the second image IM2, there is an advantage that a process for creating a judgment mask can be simplified as compared with the first embodiment. On the other hand, since background regions of the judgment images JM1 and JM2 of the first embodiment are larger than the background regions of the judgment images JM1′ and JM2′ of the second embodiment, the first embodiment has an advantage that accuracy of movement judgment process of the camera is higher.

### C. Third Embodiment

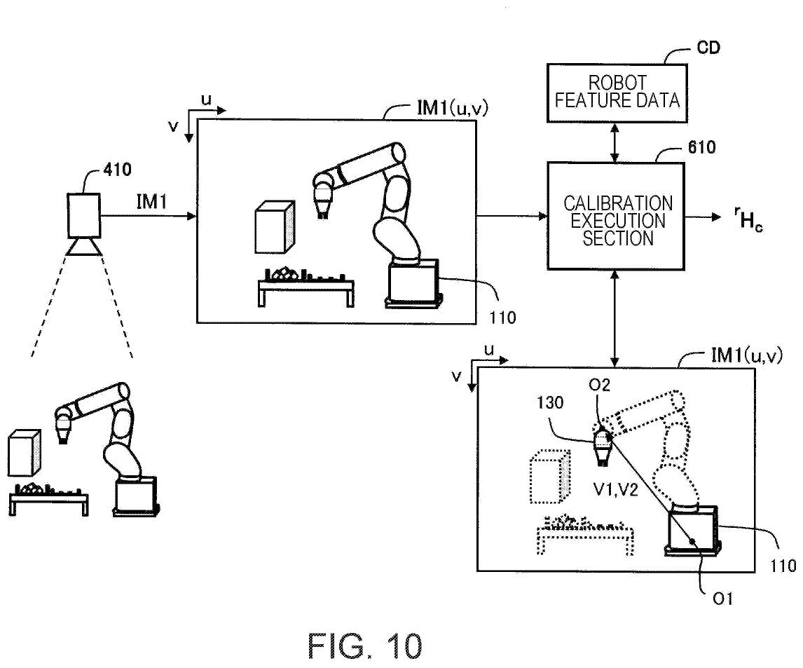

FIG. 10 is an explanatory diagram showing contents of a calibration process according to a third embodiment. The third embodiment differs from the first and second embodiments only in contents of calibration process for the camera, and the configuration of the system and the processing procedure are the same as those of the first and second embodiments.

In the first embodiment described above, an external parameter of the camera is estimated using only the pose of a non-movable section near the basal section of the robot 100, but in the third embodiment, as shown in FIG. 10, in addition to the base 110, which is the non-movable section of the robot 100, the arm portion 130 of the robot 100 is also recognized at the same time, and an external parameter is estimated using a specific position O1 of the base 110 and a specific position O2 of the arm portion 130 of the robot 100.

Among the components of Equation 4 described in the first embodiment, a translation vector t of a homogeneous transformation matrix ^{c}Hᵣ is represented by a coordinate of the specific position O1 of the base 110 in the camera coordinate system Σc as described with reference to FIG. 5.

As described below, a rotation matrix of an external parameter can be estimated using the specific position O1 of the base 110, which is a non-movable section, and the specific position O2 of the arm portion 130. As the arm portion 130, it is desirable to use a fingertip portion close to tip end of the robot arm 120. In this way, estimation accuracy of a rotation matrix can be improved. The specific position O2 of the arm portion 130 is preferably a center position of a joint included in the arm portion 130. By this, the specific position O2 of the arm portion 130 in the robot coordinate system Σr can be easily calculated from a joint angle and a link length of the robot 100.

In the calibration process of the third embodiment, the calibration execution section 610 first recognizes the specific position O1 of the base 110 and the specific position O2 of the arm portion 130 included in the first image IM1 in the camera coordinate system Σc. Coordinates of the specific position O1 of the base 110 in the camera coordinate system Σc corresponds to the translation vector t of the homogeneous transformation matrix ^{c}Hᵣ in Equation 3 and Equation 4 described above.

The calibration execution section 610 further calculates two specific positions O1 and O2 in the robot coordinate system Σr. The coordinates of the specific positions O1 and O2 in the robot coordinate system Σr can be calculated from a joint angle and a link length of the robot 100.

The calibration execution section 610 creates a first vector V1 connecting the two specific positions O1 and O2 in the camera coordinate system Σc, and creates a second vector V2 connecting the two specific positions O1 and O2 in the robot coordinate system Σr. Further, the calibration execution section 610 obtains 3×3 rotation matrix for rotating the first vector V1 in the camera coordinate system Σc to the second vector V2 in the robot coordinate system Σr. This rotation matrix corresponds to the rotation matrix R^{T} in Equation 4 described above.

The calibration execution section 610 can calculate an external parameter using the translation vector t and the rotation matrix R^{T} obtained in this way. That is, the rotation matrix of the homogeneous transformation matrix ^{r}H_{c} as an external parameter is equal to R^{T}, and a translation vector of the homogeneous transformation matrix ^{r}H_{c} can be calculated as −R^{T}·t in accordance with Equation 4 described above.

As described above, in the third embodiment, by using a relationship between the specific position O1 of the base 110, which is a non-movable section, and the specific position O2 of the arm portion 130, it is possible to obtain an external parameter with higher accuracy.

### Other Forms

The present disclosure is not limited to the above-described embodiments, and can be realized in various forms without departing from the spirit thereof. For example, the present disclosure can also be realized by the following aspects. The technical features in the above-described embodiments corresponding to the technical features in the respective embodiments described below can be appropriately replaced or combined in order to solve some or all of the problems of the present disclosure or to achieve some or all of the effects of the present disclosure. In addition, unless the technical features are described as essential features in the present specification, the technical features can be appropriately deleted.

(1) According to a first aspect of the present disclosure, a calibration method for a camera is provided. This calibration method includes a calibration step of executing a calibration process for obtaining an external parameter of the camera with respect to a robot using a first image that was taken by the camera and that includes at least a part of the robot and a judgment step of judging validity of the external parameter after execution of the calibration process. The judgment step includes (a) a step of, after execution of the calibration process, using the camera to take a second image including at least a part of the robot and (b) a step of judging whether or not a positional relationship between the camera and the robot has changed using the first image and the second image, and judging whether the external parameter is valid or invalid in accordance with presence or absence of change in the positional relationship.

According to this method, an external parameter of the camera can be obtained from a first image including at least a part of the robot without using a calibration jig. It is also possible to easily judge whether or not a calibration parameter is valid by using a second image taken by the same camera after execution of the calibration process.

(2) In the calibration method described above, the step of (b) may include (b1) a step of creating a judgment mask indicating a mask region including a region of the robot in the first image and a region of the robot in the second image; (b2) a step of creating a first judgment image obtained by excluding the mask region from the first image and a second judgment image obtained by excluding the mask region from the second image; and (b3) a step of judging whether or not the positional relationship between the camera and the robot has changed in accordance with a change in pixel values between the first judgment image and the second judgment image.

According to this calibration method, it is possible to judge whether or not a positional relationship between the camera and the robot has changed from change in pixel values in background regions of the first image and the second image.

(3) In the calibration method described above, the step of (b1) may include a step of creating a first mask indicating a first mask region including the region of the robot in the first image; a step of creating a second mask indicating a second mask region including the region of the robot in the second image; and a step of creating the judgment mask by summing the first mask and the second mask.

According to this calibration method, the judgment mask can be easily created.

(4) In the calibration method described above, the step of (b1) may include a step of recognizing the region of the robot in the first image, and creating the judgment mask so that the mask region of the judgment mask includes a region of the robot included in the first image and a movable region of a robot arm.

According to this calibration method, the judgment mask can be easily created.

(5) The calibration method described above may be such that the mask region of the judgment mask is formed so as to include a region of the robot and a region of a movement-allowed object including a workpiece.

According to this calibration method, it is possible to more accurately judge whether or not the positional relationship between the camera and the robot has changed.

(6) The calibration method described above may be such that the calibration step is a step of recognizing a specific portion that enables determining a pose of the robot from the first image and estimating the external parameter from a recognition result of the specific portion.

According to this calibration method, an external parameter of the camera can be obtained from a recognition result of the specific portion included in the first image.

(7) The calibration method described above may be such that the specific portion is a non-movable section existing near a basal section of the robot and the calibration step includes a step of recognizing, in a camera coordinate system of the camera, a pose of the non-movable section included in the first image and a step of estimating the external parameter from the pose of the non-movable section.

According to this calibration method, an external parameter of the camera can be obtained from a pose of the non-movable section.

(8) The calibration method described above may be such that the specific portion includes a non-movable section existing near a basal section of the robot and an arm portion of the robot and the calibration step includes a step of recognizing, in a camera coordinate system of the camera, a first specific position of the non-movable section and a second specific position of the arm portion, which are included in the first image; a step of calculating the first specific position and the second specific position in a robot coordinate system of the robot; a step of creating a first vector connecting the first specific position and the second specific position in the camera coordinate system and a second vector connecting the first specific position and the second specific position in the robot coordinate system, and obtaining a rotation matrix that rotates the first vector to the second vector; and a step of calculating the external parameter using the first specific position of the non-movable section in the camera coordinate system and the rotation matrix.

According to this calibration method, an external parameter of the camera can be obtained from the specific positions of the non-movable section and the arm portion.

(9) The calibration method described above may be such that the non-movable section is a base of the robot.

According to this calibration method, an external parameter of the camera can be obtained from the pose and the specific position of the base of the robot.

(10) In the calibration method described above, the calibration step includes a step of acquiring a plurality of first images by photographing using the camera at a plurality of timings and a step of determining the external parameter of the camera using an average of a plurality of external parameters estimated from the plurality of first images.

According to this calibration method, accuracy of an external parameter of the camera can be enhanced.

(11) According to a second aspect of the present disclosure, a camera calibration system is provided. This camera calibration system includes a robot; a camera installed configured to photograph the robot; a calibration execution section configured to execute a calibration process of obtaining an external parameter of the camera with respect to the robot using a first image that was taken by the camera and that includes at least a part of the robot; and a judgment section configured to judge validity of the external parameter after execution of the calibration process. The judgment section judges whether or not a positional relationship between the camera and the robot has changed using the first image and a second image that was taken by the camera after execution of the calibration process and that includes at least part of the robot, and executes a judgment process of judging whether the external parameter is valid or invalid in accordance with presence or absence of change in the positional relationship.

(12) According to a third aspect of the present disclosure, a computer program for causing a processor to execute a process of calibrating a camera is provided. The computer program causes the processor to execute a calibration process for obtaining an external parameter of the camera with respect to a robot using a first image that was taken by the camera and that includes at least part of the robot and a judgment process for judging validity of the external parameter after execution of the calibration process. The judgment process includes (a) a process of taking, after execution of the calibration process, a second image including at least a part of the robot by the camera and (b) a process of judging whether or not a positional relationship between the camera and the robot has changed using the first image and the second image, and judging whether the external parameter is valid or invalid in accordance with presence or absence of change in the positional relationship.

(13) According to a fourth aspect of the present disclosure, a calibration method for a camera is provided. This calibration method includes a calibration step of executing a calibration process for obtaining an external parameter of the camera with respect to a robot using a first image that was taken by the camera and that includes at least a part of the robot, wherein the calibration step is a step of recognizing a specific portion that enables determining a pose of the robot from the first image and estimating the external parameter from a recognition result of the specific portion.

According to this calibration method, an external parameter of the camera can be obtained from a first image including at least a part of the robot without using a calibration jig.

(14) The calibration method described above may be such that the specific portion is a non-movable section existing near a basal section of the robot and the calibration step includes a step of recognizing, in a camera coordinate system of the camera, a pose of the non-movable section included in the first image and a step of estimating the external parameter from the pose of the non-movable section.

According to this calibration method, an external parameter of the camera can be obtained from a pose of the non-movable section.

(15) The calibration method described above may be such that the specific portion includes a non-movable section existing near a basal section of the robot and an arm portion of the robot. The calibration step includes a step of recognizing, in a camera coordinate system of the camera, a first specific position of the non-movable section and a second specific position of the arm portion, which are included in the first image; a step of calculating the first specific position and the second specific position in a robot coordinate system of the robot; a step of creating a first vector connecting the first specific position and the second specific position in the camera coordinate system and a second vector connecting the first specific position and the second specific position in the robot coordinate system, and obtaining a rotation matrix that rotates the first vector to the second vector; and a step of calculating the external parameter using the first specific position of the non-movable section in the camera coordinate system and the rotation matrix.

According to this calibration method, an external parameter of the camera can be obtained from the specific positions of the non-movable section and the arm portion.

The present disclosure can be realized in various forms other than those described above. For example, the present disclosure can be realized in the form of a robot system provided with a robot and a robot information process device, a computer program for realizing the functions of the robot information process device, a non-transitory storage medium on which the computer program is recorded, or the like.

What is claimed is:

1. A calibration method for a camera, the calibration method comprising:
a calibration step of executing a calibration process for obtaining an external parameter of the camera with respect to a robot using a first image that was taken by the camera and that includes at least a part of the robot and
a judgment step of judging validity of the external parameter after execution of the calibration process, wherein
the judgment step includes
(a) a step of, after execution of the calibration process, using the camera to take a second image including at least a part of the robot and
(b) a step of judging whether or not a positional relationship between the camera and the robot has changed using the first image and the second image, and judging whether the external parameter is valid or invalid in accordance with presence or absence of change in the positional relationship.

2. The calibration method according to claim 1, wherein
the step of (b) includes
(b1) a step of creating a judgment mask indicating a mask region including a region of the robot in the first image and a region of the robot in the second image;
(b2) a step of creating a first judgment image obtained by excluding the mask region from the first image and a second judgment image obtained by excluding the mask region from the second image; and
(b3) a step of judging whether or not the positional relationship between the camera and the robot has changed in accordance with a change in pixel values between the first judgment image and the second judgment image.

3. The calibration method according to claim 2, wherein
the step of (b1) includes
a step of creating a first mask indicating a first mask region including the region of the robot in the first image;
a step of creating a second mask indicating a second mask region including the region of the robot in the second image; and
a step of creating the judgment mask by summing the first mask and the second mask.

4. The calibration method according to claim 2, wherein
the step of (b1) includes
a step of recognizing the region of the robot in the first image, and creating the judgment mask so that the mask region of the judgment mask includes a region of the robot included in the first image and a movable region of a robot arm.

5. The calibration method according to claim 2, wherein
the mask region of the judgment mask is formed so as to include a region of the robot and a region of a movement-allowed object including a workpiece.

6. The calibration method according to claim 1, wherein
the calibration step is a step of recognizing a specific portion that enables determining a pose of the robot from the first image and estimating the external parameter from a recognition result of the specific portion.

7. The calibration method according to claim 6, wherein
the specific portion is a non-movable section existing near a basal section of the robot and
the calibration process includes
a step of recognizing, in a camera coordinate system of the camera, a pose of the non-movable section included in the first image and
a step of estimating the external parameter from the pose of the non-movable section.

8. The calibration method according to claim 6, wherein
the specific portion includes
a non-movable section existing near a basal section of the robot and
an arm portion of the robot and
the calibration process includes
a step of recognizing, in a camera coordinate system of the camera, a first specific position of the non-movable section and a second specific position of the arm portion, which are included in the first image;
a step of calculating the first specific position and the second specific position in a robot coordinate system of the robot;
a step of creating a first vector connecting the first specific position and the second specific position in the camera coordinate system and a second vector connecting the first specific position and the second specific position in the robot coordinate system, and obtaining a rotation matrix that rotates the first vector to the second vector; and
a step of calculating the external parameter using the first specific position of the non-movable section in the camera coordinate system and the rotation matrix.

9. The calibration method according to claim 7, wherein
the non-movable section is a base of the robot.

10. The calibration method according to claim 1, wherein
the calibration process includes
a step of acquiring a plurality of first images by photographing using the camera at a plurality of timings and
a step of determining the external parameter of the camera using an average of a plurality of external parameters estimated from the plurality of first images.

11. A camera calibration system comprising:
a robot;
a camera installed configured to photograph the robot;
a calibration execution section configured to execute a calibration process of obtaining an external parameter of the camera with respect to the robot using a first image that was taken by the camera and that includes at least a part of the robot; and
a judgment section configured to judge validity of the external parameter after execution of the calibration process, wherein
the judgment section judges whether or not a positional relationship between the camera and the robot has changed using the first image and a second image that was taken by the camera after execution of the calibration process and that includes at least part of the robot, and executes a judgment process of judging whether the external parameter is valid or invalid in accordance with presence or absence of change in the positional relationship.

12. A calibration method for Camera, the calibration method comprising:
a calibration step of executing a calibration process for obtaining an external parameter of the camera with respect to a robot using a first image that was taken by the camera and that includes at least a part of the robot, wherein
the calibration step is a step of recognizing a specific portion that enables determining a pose of the robot from the first image and estimating the external parameter from a recognition result of the specific portion.

13. The calibration method according to claim 12, wherein
the specific portion is a non-movable section existing near a basal section of the robot and
the calibration process includes
a step of recognizing, in a camera coordinate system of the camera, a pose of the non-movable section included in the first image and
a step of estimating the external parameter from the pose of the non-movable section.

14. The calibration method according to claim 12, wherein
the specific portion includes
a non-movable section existing near a basal section of the robot and
an arm portion of the robot and the calibration process includes
a step of recognizing, in a camera coordinate system of the camera, a first specific position of the non-movable section and a second specific position of the arm portion, which are included in the first image;
a step of calculating the first specific position and the second specific position in a robot coordinate system of the robot;
a step of creating a first vector connecting the first specific position and the second specific position in the camera coordinate system and a second vector connecting the first specific position and the second specific position in the robot coordinate system, and obtaining a rotation matrix that rotates the first vector to the second vector; and
a step of calculating the external parameter using the first specific position of the non-movable section in the camera coordinate system and the rotation matrix.
